(19) United States
(12) Patent Application Publication
(10) Pub. No.: US 2019/0295015 A1
(43) Pub. Date: Sep. 26, 2019

(54) TASK MANAGEMENT SYSTEM, SERVER APPARATUS, METHOD OF CONTROLLING THE SAME, AND STORAGE MEDIUM

(71) Applicant: CANON KABUSHIKI KAISHA, Tokyo (JP)

(72) Inventor: Ryo Kosaka, Tokyo (JP)

(21) Appl. No.: 16/356,045

(22) Filed: Mar. 18, 2019

(30) Foreign Application Priority Data
Mar. 22, 2018 (JP) 2018-055102

(51) Int. Cl. G06Q 10/06; G06Q 10/10

(52) U.S. Cl. CPC G06Q 10/06311; G06Q 10/1097; G06Q 10/06316

(57) ABSTRACT

A task management system includes a server apparatus and configured to manage a task of a user by the server apparatus. In the server apparatus, an obtainment unit obtain learning data that associates a plurality of work logs each including work information of the user with a correct answer task for each work log of the plurality of work logs. A generation unit generates a learning model by machine learning based on the obtained learning data. An estimation unit estimates a task of the user for an input work log by analyzing the input work log by the machine learning using the generated learning model.

### BACKGROUND OF THE INVENTION

### Field of the Invention

The present invention relates to a task management system, a server apparatus, a method of controlling the same, and a storage medium and, mainly, to a technique of analyzing the work state and action of a user in an office and estimating a work item of the user.

### Description of the Related Art

Conventionally, a work management system aiming at increasing the efficiency of a project management work has been proposed. The work management system makes it possible to manually input the work items (to be referred to as “tasks” hereinafter) of a project, for which a user is responsible for, to a project management tool, visualize the progress of each task into an eye-friendly Gantt chart or the like, and provide it. However, the user needs to do registration of the result, progress, and the like of each task performed by himself/herself in addition to the daily task execution work, and this is a burden for the user. In addition, a manager cannot judge whether the contents registered by each user is correct.

For this reason, Japanese Patent No. 5825915 proposes a technique of registering information about a task of a user in a database in advance, estimating the task by comparing the information registered in the database with an input operation of the user on a personal computer, and recording the task together with time information.

In the above-described conventional art, to estimate the task, all pieces of information concerning the task need to be registered in the database. In such rule-based task estimation, rules to estimate each task need to be defined in advance for a variety of works, and much time and cost are required. Additionally, if the generated rules are insufficient, the task estimation accuracy lowers.

### SUMMARY OF THE INVENTION

The present invention has been made in consideration of the above-described problems. The present invention provides a technique of, in a task management system configured to manage a task of a user, estimating the task from a work log using machine learning without the necessity of defining, in advance, rules to estimate the task.

According to one aspect of the present invention, there is provided a task management system including a server apparatus and configured to manage a task of a user by the server apparatus, wherein the server apparatus comprises: an obtainment unit configured to obtain learning data that associates a plurality of work logs each including work information of the user with a correct answer task for each work log of the plurality of work logs; a generation unit configured to generate a learning model by machine learning based on the learning data obtained by the obtainment unit; and an estimation unit configured to estimate a task of the user for an input work log by analyzing the input work log by the machine learning using the learning model generated by the generation unit.

According to another aspect of the present invention, there is provided a server apparatus of a task management system configured to manage a task of a user, comprising: an obtainment unit configured to obtain learning data that associates a plurality of work logs each including work information of the user with a correct answer task for each work log of the plurality of work logs; a generation unit configured to generate a learning model by machine learning based on the learning data obtained by the obtainment unit; and an estimation unit configured to estimate a task of the user for an input work log by analyzing the input work log by the machine learning using the learning model generated by the generation unit.

According to still another aspect of the present invention, there is provided a method of controlling a server apparatus of a task management system configured to manage a task of a user, the method comprising: obtaining learning data that associates a plurality of work logs each including work information of the user with a correct answer task for each work log of the plurality of work logs; generating a learning model by machine learning based on the obtained learning data; and estimating a task of the user for an input work log by analyzing the input work log by the machine learning using the generated learning model.

According to yet another aspect of the present invention, there is provided a non-transitory computer-readable storage medium storing a computer program for causing a computer to execute a method of controlling a server apparatus of a task management system configured to manage a task of a user, the method comprising: obtaining learning data that associates a plurality of work logs each including work information of the user with a correct answer task for each work log of the plurality of work logs; generating a learning model by machine learning based on the obtained learning data; and estimating a task of the user for an input work log by analyzing the input work log by the machine learning using the generated learning model.

According to the present invention, in a task management system configured to manage a task of a user, it is possible to estimate the task from a work log using machine learning without the necessity of defining, in advance, rules to estimate the task.

Further features of the present invention will become apparent from the following description of exemplary embodiments (with reference to the attached drawings).

### BRIEF DESCRIPTION OF THE DRAWINGS

FIG. 1 is a block diagram showing an example of the arrangement of a work management system 100.

FIG. 2A is a block diagram showing an example of the functional arrangement of a server apparatus 130.

FIGS. 2B and 2C are views showing examples of a work log and tasks for each theme.

FIGS. 3A to 3D are views showing examples of various kinds of work logs 210 stored in a storage unit 133.

FIGS. 4A to 4C are views showing examples of a task list DB 260, learning data 270, and a task estimation result 244 stored in the storage unit 133, respectively.

FIG. 5A is a flowchart showing the procedure of learning model generation processing.

FIG. 5B is a flowchart showing the procedure of task estimation processing.

FIG. 6A is a block diagram showing an example of the functional arrangement of a server apparatus 130 according to the second embodiment.

FIG. 6B is a block diagram showing an example of the functional arrangement of a server apparatus 130 according to the third embodiment.

FIG. 7A is a flowchart showing the procedure of report generation processing according to the second embodiment.

FIGS. 7B and 7C are views showing examples of a setting screen concerning a generation report according to the second embodiment.

FIG. 7D is a flowchart showing the procedure of report generation processing according to the second embodiment.

FIGS. 8A to 8F are views showing examples of totalization of the man-hours of tasks and examples of man-hour totalization results according to the second embodiment.

FIGS. 9A to 9E are views showing examples of output screens of reports generated by the server apparatus 130 according to the second embodiment.

FIG. 10A is a flowchart showing the procedure of report generation processing according to the third embodiment.

FIGS. 10B and 10C are views showing examples of a UI screen for task modification according to the third embodiment.

FIG. 10D is a flowchart showing the procedure of task modification processing according to the third embodiment.

FIG. 11 is a flowchart showing the procedure of task estimation processing according to the fourth embodiment.

### DESCRIPTION OF THE EMBODIMENTS

Hereinafter, embodiments of the present invention will be described in detail with reference to the accompanying drawings. It should be noted that the following embodiments are not intended to limit the scope of the appended claims, and that not all the combinations of features described in the embodiments are necessarily essential to the solving means of the present invention.

### First Embodiment

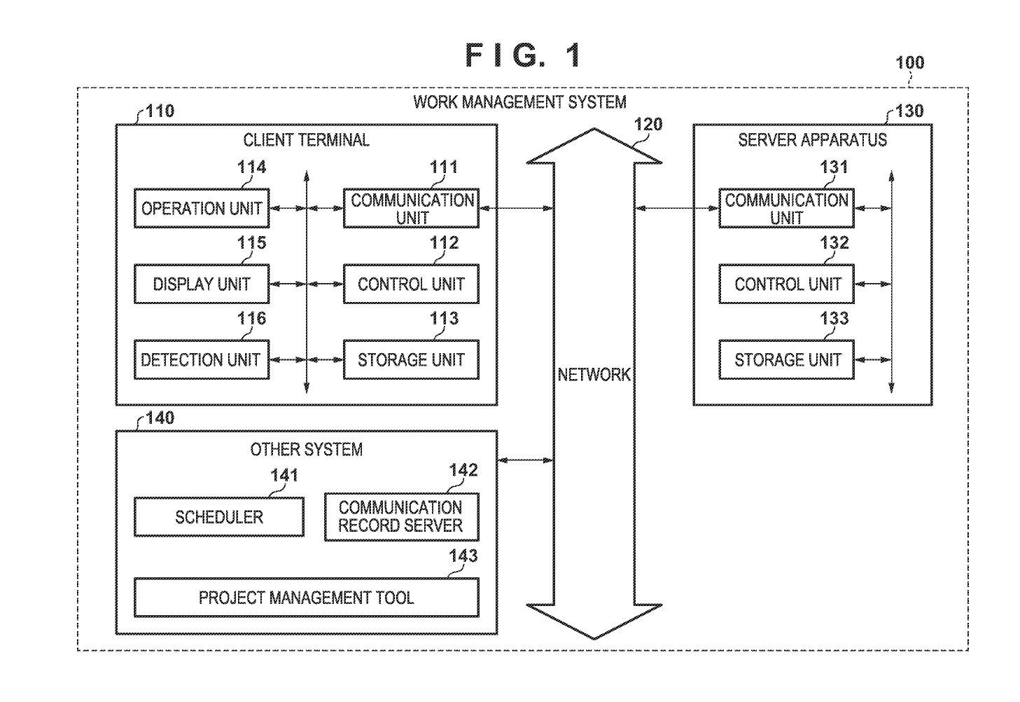

The first embodiment will be described with reference to FIGS. 1 to 5B.

<Arrangement of Work Management System>

FIG. 1 is a block diagram showing an example of the arrangement of a work management system 100 according to this embodiment. The work management system 100 is formed by a client terminal 110, a server apparatus 130, and another system 140, and these are connected to each other via a network 120. Note that FIG. 1 shows the single client terminal 110 and the single server apparatus 130. However, a plurality of client terminals and a plurality of server apparatuses may be connected to the network 120. In this embodiment, the work management system 100 is an example of a task management system that includes the server apparatus 130 and manages the tasks of a user by the server apparatus 130.

The client terminal 110 is used by the user to perform a series of operation inputs associated with work of the user as a work management target. The client terminal 110 performs processing such as processing of collecting data (to be referred to as “work logs” hereinafter) representing a work state of the user and transmitting the data to the server apparatus 130 and processing of displaying the work state in response to a request of the user.

The server apparatus 130 performs processing of analyzing work logs transmitted from the client terminal 110 and the other system 140, thereby estimating (specifying) a task of the user and storing it as a work result.

The other system 140 includes systems such as a scheduler 141 configured to manage the daily schedule of the user, a communication record server 142 configured to manage a communication record on an extension/outside line or a web conference tool, and a project management tool 143 configured to manage the daily progress of tasks. These systems are individually connected as single devices to the network 120 and transmit work logs to the server apparatus 130. Note that various kinds of systems necessary for project management other than the systems shown in FIG. 1 may be added as the other system 140.

The network 120 is formed by a LAN and communicably connects the client terminal 110, the server apparatus 130, and the other system 140. The network 120 is used to transmit/receive data such as a user's work log or work result.

<Arrangement of Client Terminal 110>

The client terminal 110 can be implemented by a general personal computer (PC) or the like. In this embodiment, the client terminal 110 includes a communication unit 111, a control unit 112, a storage unit 113, an operation unit 114, a display unit 115, and a detection unit 116.

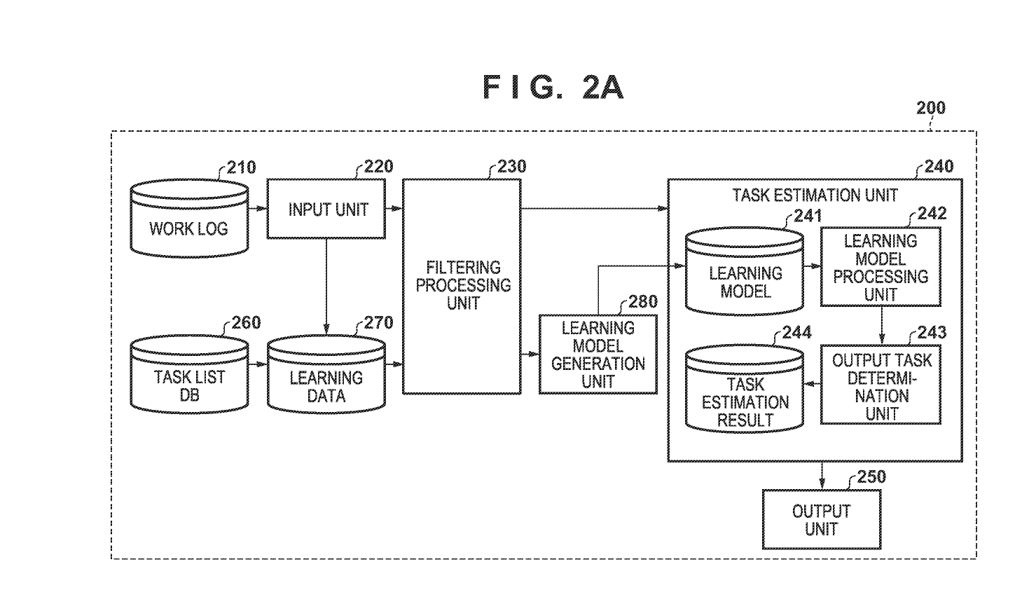

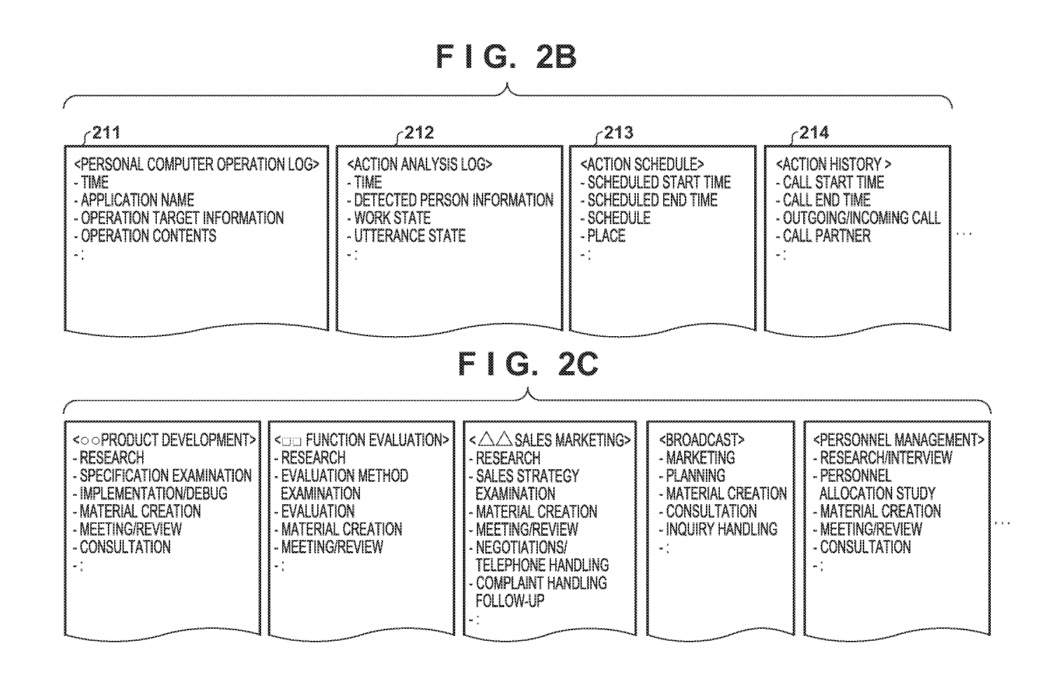

The communication unit 111 is a communication interface unit configured to transmit/receive data to/from the server apparatus 130 via the network 120. The communication unit 111 is used to transmit a personal computer operation log 211 collected by the operation unit 114 and an action analysis log 212 collected by the detection unit 116 to the server apparatus 130 as a user's work log 210 (FIG. 2A) to be described later. The work log 210 may be transmitted in real time at the timing of detection, or may be transmitted based on a predetermined time or a predetermined amount.

The control unit 112 is formed by a CPU and the like. The control unit 112 functions as a processing unit configured to process data handled in the client terminal 110 by executing a program stored in the storage unit 113. The control unit 112 has a function of performing control to collect and transmit the work log 210 obtained from the operation unit 114 or the detection unit 116.

The storage unit 113 is formed by storage devices such as a ROM, a RAM, and an HDD. The storage unit 113 stores data and programs handled in the client terminal 110 by the control unit 112. The personal computer operation log 211 collected by the operation unit 114 to be described later, the action analysis log 212 collected by the detection unit 116, and the like may temporarily be stored in the storage unit 113.

The operation unit 114 is formed by a keyboard, a mouse, and the like. The operation unit 114 functions as a processing unit configured to, upon accepting an operation input such as key pressing or a mouse click operation from the user, collect the personal computer operation log 211 associated with the work of the user at that time. Details of the personal computer operation log 211 collected by the operation unit 114 will be described later.

The display unit 115 is formed by a display and the like. The control unit 112 displays, on the display unit 115, an output screen by a program for document creation, spreadsheet, presentation creation, schedule management, project management, or the like executed in association with work of the user.

The detection unit 116 is formed by a camera, a microphone, and the like. The detection unit 116 functions as a processing unit configured to collect the action analysis log 212 such as the seated/non-seated state of the user or a conversation action with another user detected in association with work of the user. Details of the action analysis log 212 collected by the detection unit 116 will be described later. Note that in FIG. 1, the detection unit 116 is integrated with the client terminal 110. However, an arrangement in which the detection unit 116 itself functions as a single device and is connected to the network 120 may be used.

<Arrangement of Server Apparatus 130>

The server apparatus 130 includes a communication unit 131, a control unit 132, and a storage unit 133.

The communication unit 131 is a communication interface unit configured to transmit/receive data to/from the client terminal 110 via the network 120.

The control unit 132 is formed by a CPU and the like. The control unit 132 functions as a processing unit configured to process data handled in the server apparatus 130 by executing a program stored in the storage unit 133. The control unit 132 has a function of analyzing the work log 210 received via the communication unit 131.

The storage unit 133 is formed by storage devices such as a ROM, a RAM, and an HDD. The storage unit 133 stores data and a control program 200 (FIG. 2A) handled in the server apparatus 130 by the control unit 132. The work log 210 received via the communication unit 131, an analysis result by the control unit 132, and the like may temporarily be stored in the storage unit 133.

<Functional Arrangement of Server Apparatus 130>

FIG. 2A is a block diagram showing an example of the functional arrangement of a server apparatus 130 implemented by the control program 200 executed by the server apparatus 130. The control program 200 of the work management system 100 is stored in the storage unit 133, as described above. The CPU of the control unit 132 reads out the control program 200 from the storage unit 133 and executes it at the time of activation of the server apparatus 130, thereby implementing the functional arrangement shown in FIG. 2A in the server apparatus 130.

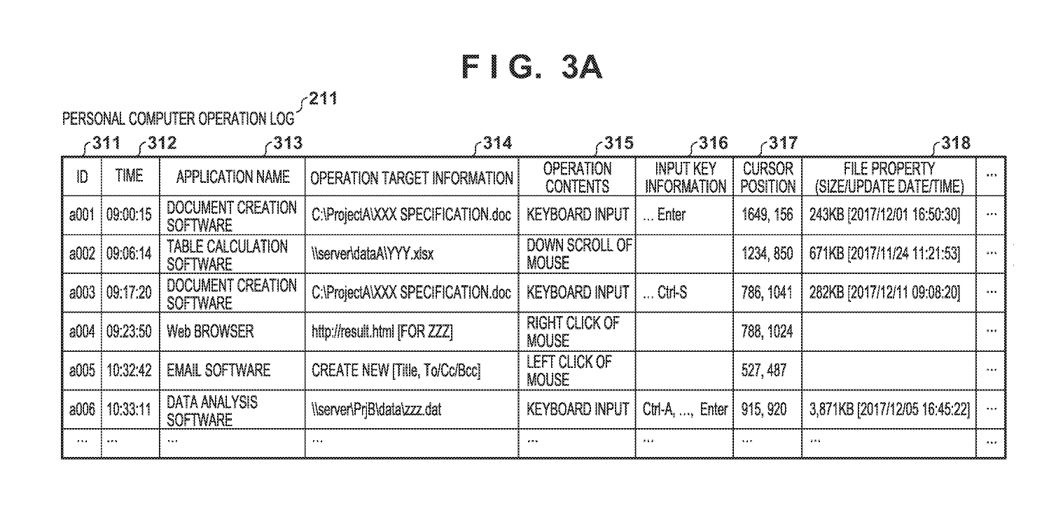

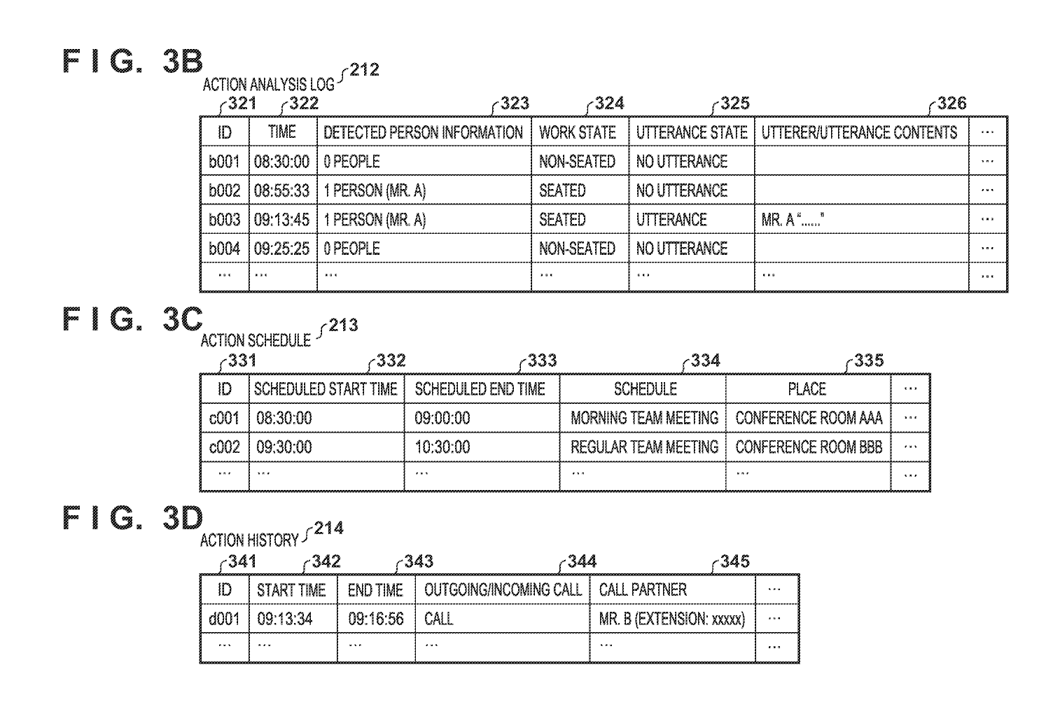

The work log 210 represents data collected and transmitted by the client terminal 110 and data that can be obtained by the other system 140, and includes the work information of the user. The work log 210 is received via the communication unit 131 and stored in the storage unit 133. Note that details of the work log 210 will be described later with reference to FIGS. 2B and 3A to 3D.

An input unit 220 obtains, as input data, the work log 210 stored in the storage unit 133.

A filtering processing unit 230 performs filtering processing with respect to information included in the work log 210. The filtering processing unit 230 extracts, from the work log 210, analysis elements needed for processing of estimating a task by a task estimation unit 240 and processing of generating a learning model 241 by a learning model generation unit 280. The filtering processing unit 230 further converts the extracted analysis elements into a predetermined format.

The task estimation unit 240 estimates a task by analyzing a filtered work log using machine learning. The task estimation unit 240 includes the learning model 241, a learning model processing unit 242, an output task determination unit 243, and a task estimation result 244.

The learning model processing unit 242 analyzes an input work log by machine learning using the learning model 241 generated in advance by the learning model generation unit 280 to be described later, thereby estimating a task of the user for the input work log. In this embodiment, the learning model processing unit 242 estimates an evaluation value for a predetermined task registered in a task list DB 260 using the learning model 241 generated in advance by the learning model generation unit 280 for the filtered work log.

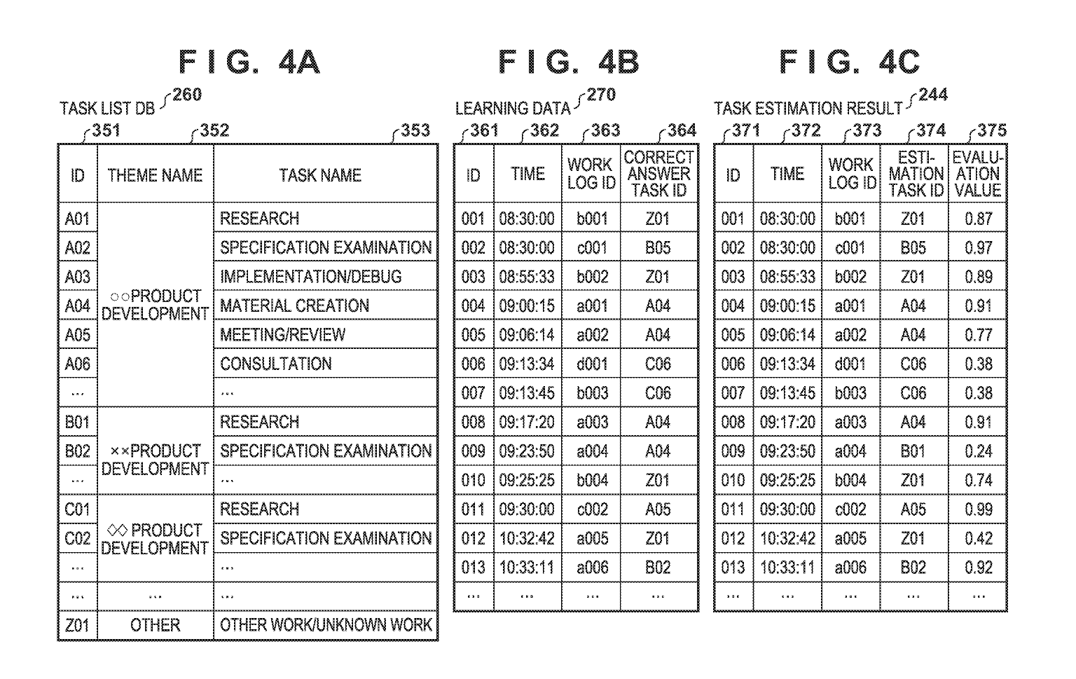

The output task determination unit 243 determines a task to be output as the estimation result of the task estimation unit 240 based on the evaluation value evaluated by the learning model processing unit 242, and records it in the task estimation result 244. Note that details of the task estimation result 244 will be described later with reference to FIG. 4C.

An output unit 250 transmits the task estimated by the task estimation unit 240 to the client terminal 110 via the communication unit 131.

The task list DB 260 is a database in which all tasks for which the user may perform work are registered, and is stored in the storage unit 133. Note that details of the task list DB 260 will be described later with reference to FIG. 4A.

The learning model generation unit 280 generates the learning model 241 by machine learning based on learning data obtained by the input unit 220. In this embodiment, the learning model generation unit 280 generates the learning model 241 from a work log obtained by filtering learning data 270. Note that details of the learning data 270 will be described later with reference to FIG. 4B.

<Work Log 210>

An example of the work log 210 stored in the storage unit 133 will be described next with reference to FIGS. 2B and 3A to 3D.

FIG. 2B is a view showing an example of the work log 210. The work log 210 includes at least one of the personal computer operation log 211 associated with an operation by the user on the personal computer, the action analysis log 212 associated with a user's action obtained from video or voice information, an action schedule 213 of the user, and an action history 214 of the user. The personal computer operation log 211 can be collected by the operation unit 114 of the client terminal 110. The action analysis log 212 can be collected by the detection unit 116 based on a voice/video. The action schedule 213 and the action history 214 can be collected from the other system 140.

FIG. 3A shows an example of the personal computer operation log 211. The personal computer operation log 211 includes pieces of field information such as an ID 311, a time 312, an application name 313, operation target information 314, operation contents 315, input key information 316, a cursor position 317, and a file property 318. For example, in a case of a document, the name of a path on which a file is saved and a file name are stored in the operation target information 314. In a case of web browsing, a URL and a web page title are stored. In a case of mail software, pieces of information such as a transmission partner and a subject are stored.

Note that the personal computer operation log 211 may include field information other than the field information shown in FIG. 3A. For example, pieces of information such as a document, the full text of a web page, the text of mail and an attached file name, and GUI part information (a menu item name or a button name) on which a mouse operation is performed can also be collected and added as new field information.

FIG. 3B shows an example of the action analysis log 212. The action analysis log 212 includes pieces of field information obtained by analyzing video information from the camera and voice data (voice information) from the microphone in addition to an ID 321 and a time 322. For example, person information 323 (the number of persons, the names of persons, and the like) detected by a predetermined video analysis technique and a work state 324 (non-seated, seated, moving, and the like) of each person can be included in the field information. Additionally, it is possible to detect an utterance state and utterance contents and specify an utterer by a predetermined voice analysis technique and utterer specifying technique. An utterance state (presence/absence of an utterance) 325 and utterer/utterance contents 326 are stored in the field information.

Note that the action analysis log 212 may include field information other than the field information shown in FIG. 3B. For example, whether a person is in a dialog state or not may be detected based on a sight line direction, an utterance timing, and the like, and the detected dialog state may be added to the utterance state 325.

FIG. 3C shows an example of the action schedule 213 collected from the scheduler 141. The action schedule 213 includes pieces of field information such as an ID 331, a scheduled start time 332, a scheduled end time 333, a schedule 334, and a place 335. Note that the action schedule 213 may include field information other than the field information shown in FIG. 3C. For example, the information of each participant in a conference and the information of an agenda and the like may be collected and added as new field information.

FIG. 3D shows an example of the action history 214 collected from the communication record server 142 or the project management tool 143. The action history 214 includes pieces of field information such as an ID 341, a start time 342, an end time 343, outgoing/incoming call information 344, and a communication partner 345. Note that the action history 214 may include field information other than the field information shown in FIG. 3D.

<Task List DB 260>

An example of the task list DB 260 will be described next with reference to FIGS. 2C and 4A.

FIG. 4A shows an example of the task list DB 260. In the task list DB 260, all theme names 352 and task names 353 in which each user is concerned are registered as individual tasks in association with IDs 351.

FIG. 2C shows examples of the theme names and the task names. For example, concerning a user who is involved in product development, task names such as “research”, “specification examination”, “implementation/debug”, “material creation”, “meeting/review”, and “consultation” are registered for a theme name “◯◯ product development”. Concerning a user who is involved in quality assurance, task names such as “research”, “evaluation method examination”, “evaluation”, “material creation”, and “meeting/review” are registered for a theme name “□□ function evaluation”. Concerning a user in the sales department, task names such as “research”, “sales strategy examination”, “material creation”, “meeting/review”, “business negotiation/telephone answering”, and “complaint handling/follow-up” are registered for a theme name “ΔΔ sales”. Note that the theme name and the task names can be registered even for a user of a job other than the above-described jobs. The types and abstraction degrees of the theme name and task names to be registered can freely be set.

<Learning Data 270>

An example of the learning data 270 will be described next with reference to FIG. 4B.

FIG. 4B shows an example of the learning data 270. The learning data 270 is data including, as a pair, the work log 210 and one corresponding task (to be referred to as a “correct answer task” hereinafter) of the tasks registered in the task list DB 260, which is associated with the work log. That is, the learning data 270 is data that associates a plurality of work logs with a correct answer task for each work log of the plurality of work logs. The learning data 270 is stored in the storage unit 133. For example, as shown in FIG. 4B, the learning data 270 includes, as field information, an ID 361, a time 362, a work log ID 363, and a correct answer task ID 364.

In the time 362 and the work log ID 363, the pieces of time information (times 312, 322, 332, and 342) and the IDs (IDs 311, 321, 331, and 341) included in the work logs shown in FIGS. 3A to 3D are stored. In the example of FIG. 4B, data corresponding to the IDs 361 included in the learning data 270 are sorted time-serially based on the time information stored in the time 362.

In the correct answer task ID 364, the ID 351 of a correct answer task corresponding to each work log is stored. Note that in this example, one correct answer task ID is associated with one work log ID. However, one correct answer task ID may be associated with a plurality of work logs within a predetermined time or a plurality of work logs of a predetermined amount.

<Task Estimation Result 244>

An example of the task estimation result 244 will be described next with reference to FIG. 4C.

FIG. 4C shows an example of the task estimation result 244. For example, the task estimation result 244 includes, as field information, an ID 371, a time 372, a work log ID 373, an estimated task ID 374, and an evaluation value 375. In the task estimation result 244, an output task (estimated task ID 374) determined by the output task determination unit 243 and an evaluation value (evaluation value 375) are recorded in association with a work log (work log ID 373). The output task corresponds to a task estimated by the task estimation unit 240, and the estimated task ID 374 is an ID (identifier) indicating the estimated task.

Note that the task estimation result 244 may include field information other than the field information shown in FIG. 4C. For example, field information used to record true/false information of a determination result may be added. Additionally, this example shows an example of a case in which one task is estimated for one work log ID. On the other hand, in a case in which one task is estimated for a plurality of work logs within a predetermined time or a plurality of work logs of a predetermined amount, a plurality of work log IDs and the estimated task ID may be associated with each other.

<Learning Model Generation Processing>

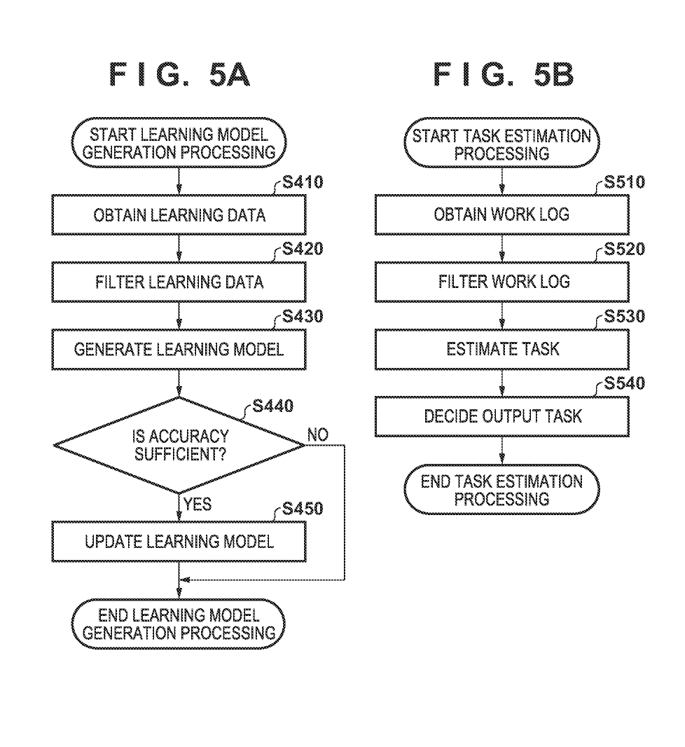

An example of generation processing of generating, in the server apparatus 130, the learning model 241 used to estimate a task for the work log 210 sent from the client terminal 110 will be described next with reference to the flowchart of FIG. 5A. The process of each step shown in FIG. 5A can be implemented in the server apparatus 130 when the CPU of the control unit 132 reads out the control program 200 from the storage unit 133 and executes it.

In step S410, the input unit 220 of the server apparatus 130 obtains the learning data 270 shown in FIG. 4B from the storage unit 133.

Next, in step S420, the filtering processing unit 230 filters information (work log) included in the learning data 270, thereby extracting only analysis elements necessary for generating a learning model to be described later. Furthermore, the filtering processing unit 230 converts the filtered information (extracted analysis elements) into a format suitable for the input data format of the algorithm of machine learning used by the learning model processing unit 242.

For example, analysis elements such as the time 312, the application name 313, and the operation target information 314 can be extracted from the personal computer operation log 211 collected in the client terminal 110. The time 312 can be used as time information to calculate the execution time of a task. The application name 313 can be used to detect software associated with the task. The operation target information 314 is information such as file path/file name/mail transmission destination/mail subject/URL/web site title, and can be used to specify document information and web browsing/mail information associated with the task. In addition, file text/mail text/web site text may be obtained to extract full text information or frequently appearing keywords from the full text. In addition, pieces of information usable for task analysis, such as folder creator information, a file size, and specific UI operation contents such as button and menu selection may be extracted. Furthermore, pieces of information concerning a task can be extracted similarly from the action analysis log 212, the action schedule 213, and the action history 214.

Next, in step S430, the learning model generation unit 280 generates a learning model using machine learning based on the work log and the correct answer task included in the learning data 270 after filtering by the filtering processing unit 230. The learning model is a model used to estimate, for one or a plurality of filtered work logs (within a predetermined time or of a predetermined amount), an evaluation value indicating the degree of association (relevance level) with each task registered in the task list DB 260. When learning is performed by associating a work log with a correct answer task, an evaluation value for an estimated task can be estimated even for an unknown work log.

Next, in step S440, the learning model generation unit 280 determines whether estimation accuracy when estimating a task using the learning model generated in step S430 is sufficient. Upon determining that the estimation accuracy is sufficient, the learning model generation unit 280 advances the process to step S450. Upon determining that the estimation accuracy is insufficient, the learning model generation unit 280 ends the processing.

Note that to obtain the estimation accuracy, for example, a cross-validation method can be used. In this method, the learning data 270 is divided into data for learning and data for validation, and a learning model is generated based on the learning data assigned to learning. In addition, when the learning model is used, the accuracy of the learning model is calculated by determining the ratio to output the learning data assigned to validation as a correct answer task. If the calculated accuracy satisfies a predetermined standard (for example, exceeds a predetermined threshold), the learning model generation unit 280 determines that the estimation accuracy is sufficient. If the calculated accuracy does not satisfy the standard, the learning model generation unit 280 determines that the estimation accuracy is insufficient.

In step S450, the learning model generation unit 280 updates the learning model generated in step S430 as the learning model 241 for task estimation and ends the processing.

<Task Estimation Processing>

An example of estimation processing of estimating, in the server apparatus 130, a task for the work log 210 sent from the client terminal 110 will be described next with reference to the flowchart of FIG. 5B. The process of each step shown in FIG. 5B can be implemented in the server apparatus 130 when the CPU of the control unit 132 reads out the control program 200 from the storage unit 133 and executes it.

In step S510, the input unit 220 of the server apparatus 130 obtains the work log 210 shown in FIGS. 3A to 3D from the storage unit 133.

Next, in step S520, the filtering processing unit 230 performs the same processing as in step S420 of FIG. 5A to filter information included in the work log 210, thereby extracting only analysis elements necessary for task determination processing to be described later. Furthermore, the filtering processing unit 230 converts the filtered information (extracted analysis elements) into a format suitable for the input data format of the algorithm of machine learning used by the learning model processing unit 242.

Next, in step S530, the learning model processing unit 242 estimates a task for the work log by machine learning using the work log 210 (input work log) filtered in step S520 and the learning model 241 generated in advance. That is, the learning model processing unit 242 analyzes the input work log by machine learning using the learning model 241, thereby estimating a task of the user for the input work log.

In this embodiment, at the same time as the task estimation, the learning model processing unit 242 generates an evaluation value for each of a plurality of tasks registered in advance in the task list DB 260 by machine learning using the learning model 241. This evaluation value is a value indicating the degree of association (relevance level) between the input work log and each task registered in the task list DB 260. Note that the learning model generation unit 280 may estimate one task for one work log or may estimate one task for a plurality of work logs within a predetermined time or a plurality of work logs of a predetermined amount.

In step S540, based on the evaluation values generated in step S530, the output task determination unit 243 decides an output task to be output as an estimation result from among the plurality of tasks registered in advance in the task list DB 260. In this example, the output task determination unit 243 decides the task corresponding to the maximum evaluation value as the output task (estimated task). The output task determination unit 243 stores the decided estimated task in the task estimation result 244 shown in FIG. 4C and ends the processing.

As described above, the server apparatus 130 according to this embodiment obtains the learning data 270 that associates a plurality of work logs each including the work information of the user with a correct answer task for each work log of the plurality of work logs. The server apparatus 130 generates the learning model 241 by machine learning based on the obtained learning data 270. Using the work log 210 as the input work log, the server apparatus 130 analyzes the input work log by machine learning using the generated learning model 241, thereby estimating the task of the user for the input work log.

As described above, according to this embodiment, the work log 210 such as the personal computer operation log 211, the action analysis log 212, the action schedule 213, or the action history 214 is input, and task estimation processing based on machine learning is executed, thereby automatically performing task estimation. This makes it possible to a task from a work log using machine learning without the necessity of defining, in advance, rules to estimate the task, and also improve the task estimation accuracy while reducing time and cost of rule creation.

### Second Embodiment

The first embodiment provides a mechanism configured to estimate a task from a work log of a user. The second embodiment provides a mechanism configured to totalize man-hours of each task of a user in a predetermined period, convert the result into an appropriate format, and output it as a report. Note that portions different from the first embodiment will be described below.

<Functional Arrangement of Server Apparatus 130>

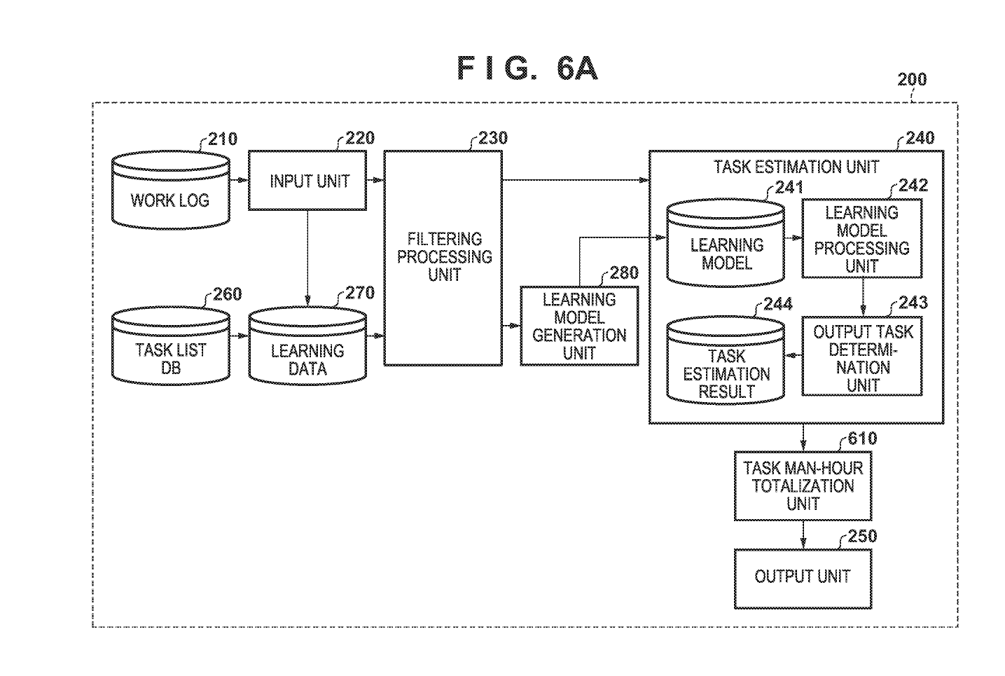

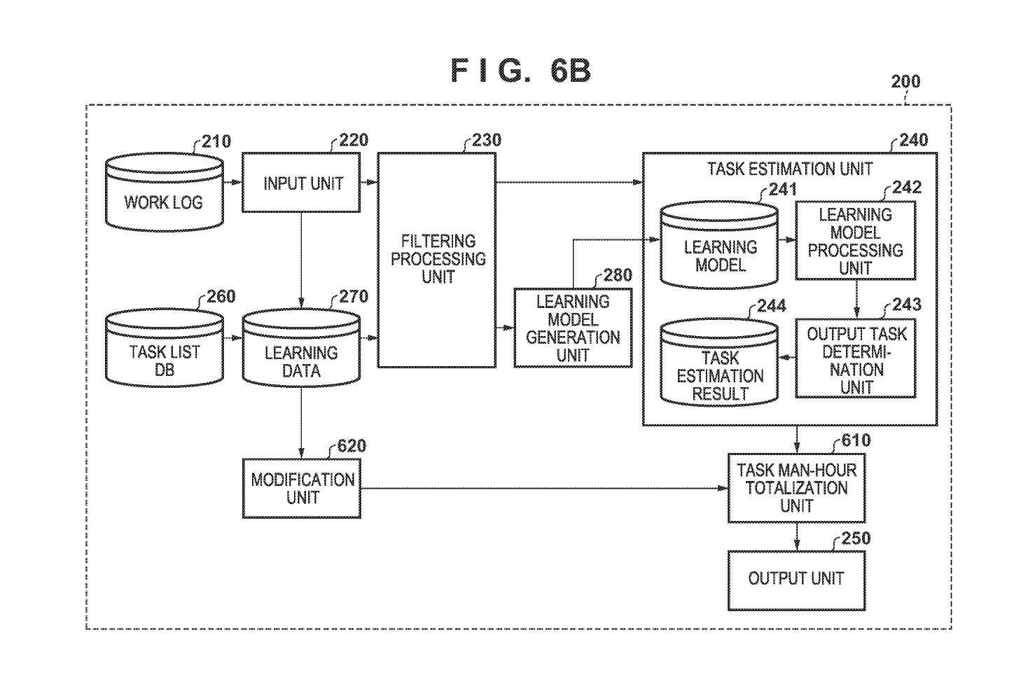

FIG. 6A is a block diagram showing an example of the functional arrangement of a server apparatus 130 implemented by a control program 200 executed by the server apparatus 130 according to this embodiment. In this embodiment, a task man-hour totalization unit 610 is added to the functional arrangement of the server apparatus 130.

The task man-hour totalization unit 610 totalizes the total execution time (to be referred to as a “man-hour” hereinafter) of each task based on all tasks in a predetermined period, which are estimated by a task estimation unit 240, and generates a report that visualizes the totalization result of the man-hour (work man-hour).

An output unit 250 transmits the tasks estimated by the task estimation unit 240, the man-hour of each task calculated by the task man-hour totalization unit 610, and the generated report to a client terminal 110 via a communication unit 131.

<Report Display Processing>

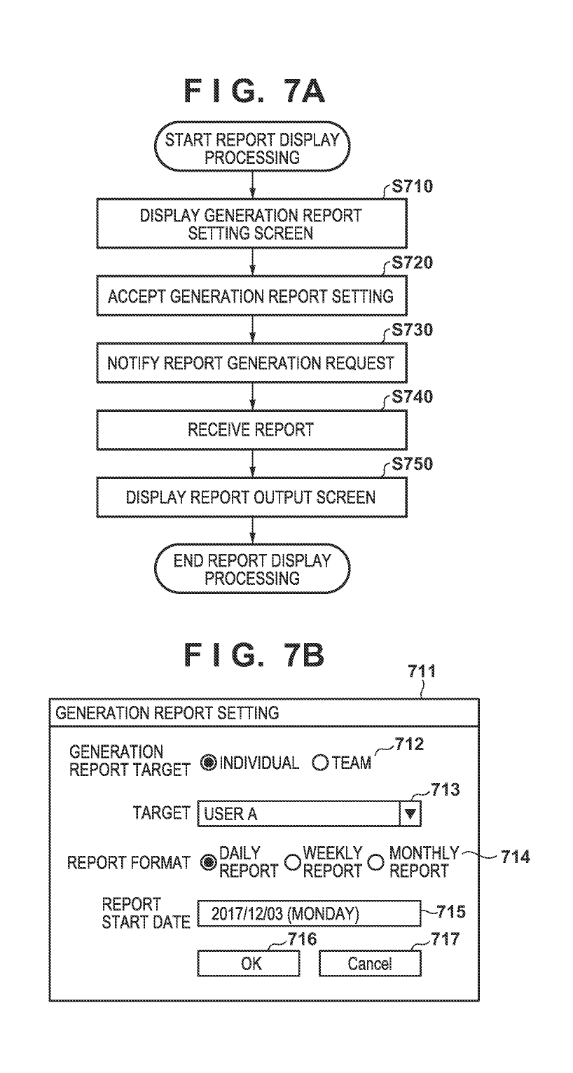

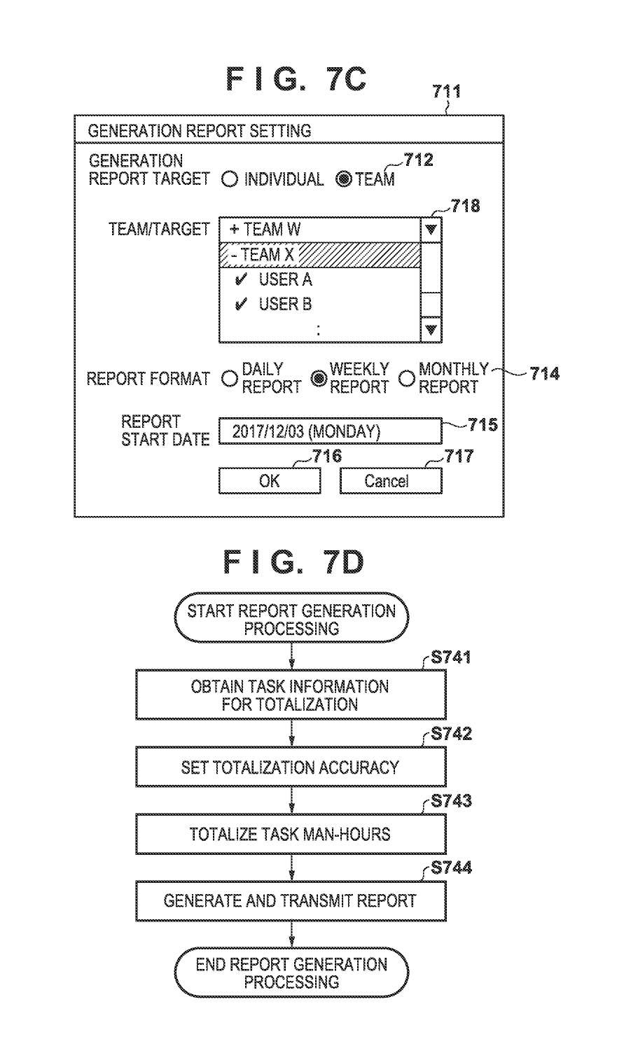

An example of processing of displaying a report that visualizes the work of the user on a display unit 115 of the client terminal 110 in a work management system 100 according to this embodiment will be described next with reference to the flowchart of FIG. 7A. The process of each step shown in FIG. 7A can be implemented in the client terminal 110 when the CPU of a control unit 112 reads out a control program from a storage unit 113 and executes it.

In step S710, the control unit 112 displays a setting screen 711 concerning a generation report as shown in FIGS. 7B and 7C on the display unit 115. Furthermore, in step S720, the control unit 112 accepts settings (generation report settings) concerning a report to be generated by the server apparatus 130 from the user by an operation on the setting screen 711 performed using an operation unit 114. Note that details of the generation report settings will be described later. When the setting by the user is completed, the operation unit 114 sends a setting completion notification to the control unit 112.

Next, upon receiving the setting completion notification from the operation unit 114, in step S730, the control unit 112 transmits (notifies) a report generation request to the server apparatus 130 via a communication unit 111. The report generation request includes the setting contents accepted from the user via the setting screen 711. Upon receiving, via the communication unit 131, the report generation request transmitted from the client terminal 110, the server apparatus 130 executes report generation processing (FIG. 7D) in accordance with the received report generation request, and transmits the generated report to the client terminal 110. Note that details of the report generation processing will be described later.

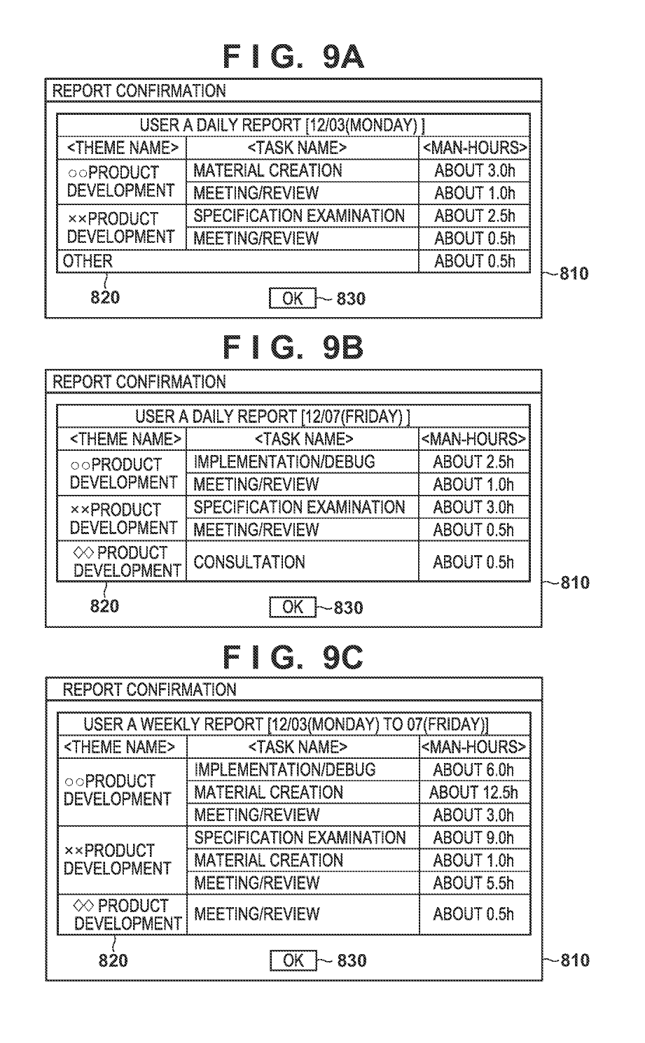

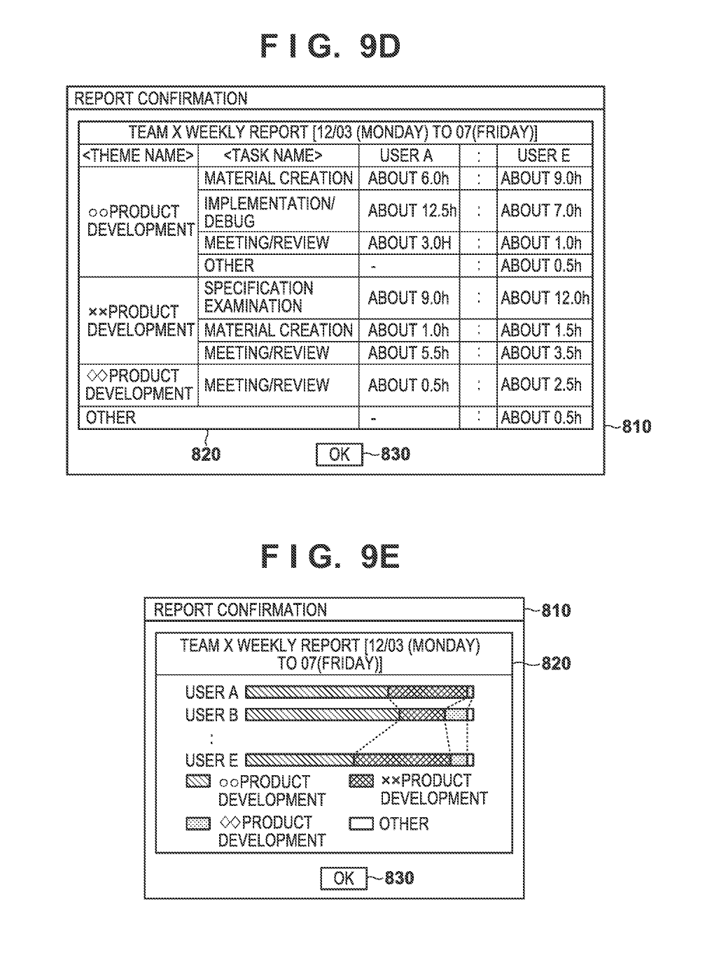

Finally, in step S740, the control unit 112 receives, via the communication unit 111, the report transmitted from the server apparatus 130. Upon receiving the report, in step S750, the control unit 112 displays the received report on the display unit 115 as an output screen 810 as shown in FIGS. 9A and 9B, and ends the processing.

<Settings Concerning Generation Report>

A method of doing settings concerning the generation report by the user using the setting screen 711 in step S720 will be described next with reference to FIGS. 7B and 7C.

The user selects the target of the report to be generated using a selection button 712. To generate a report for an individual, “individual” is selected, as shown in FIG. 7B. To generate a report for a team, “team” is selected, as shown in FIG. 7C.

In a report target list 713, the target person of the report to be generated is selected. In a case of a report of an individual, one target person is selected from the report target list 713. In a case of a report of members, a team and a plurality of target persons are selected from a report target list 718. Note that when users and teams for which a report can be generated and users belonging to each team are set in advance, they can be displayed as lists in the report target lists 713 and 718. In addition, arbitrary users can also be selected from all users and set as an arbitrary team.

In a report format setting 714, a report format to be output is set. As the output report format, one of a daily report that organizes work contents of one day, a weekly report that organizes work contents of one week, and a monthly report that organizes work contents of one month is selected. Note that the output report formats are not limited to the formats shown in FIGS. 7B and 7C, and, for example, a report for half a day or a report for a development process in several months may be selectable as the output report format.

In a report starting date setting 715, the analysis starting date of the report to be output is designated. In a case of a daily report, a report of the designated starting date is generated. In a case of a weekly report or a monthly report, a report of one week or one month from the starting date is generated.

When the user completes all settings and presses an OK button 716, the operation unit 114 transmits a setting completion notification to the control unit 112. Note that to cancel the report generation, the user presses a Cancel button 717. The setting completion notification includes the above-described setting contents on the setting screen 711.

<Report Generation Processing>

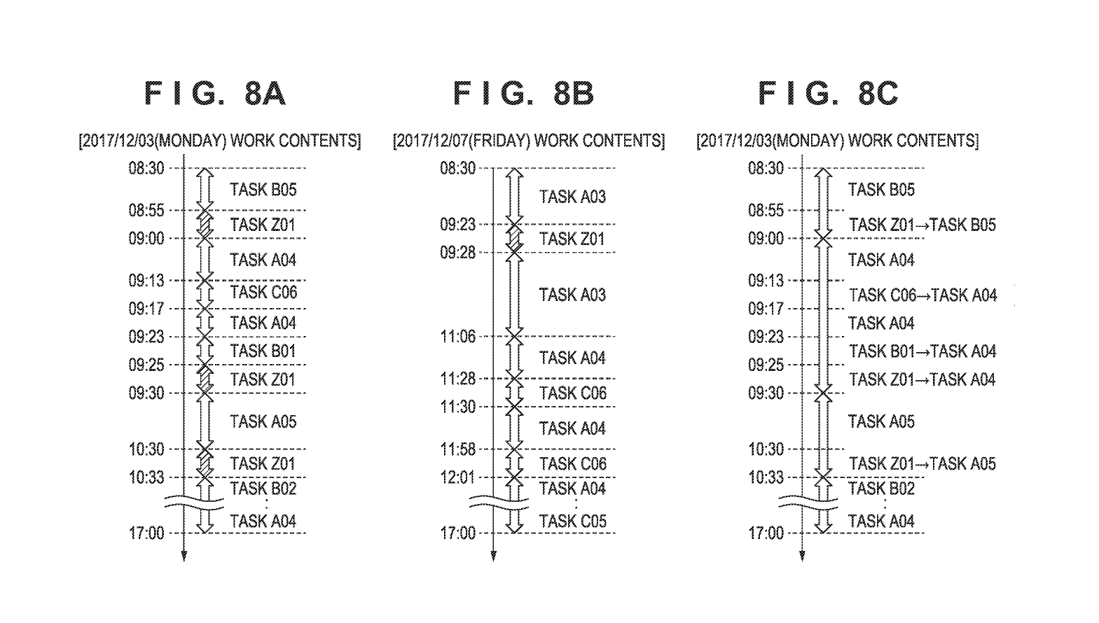

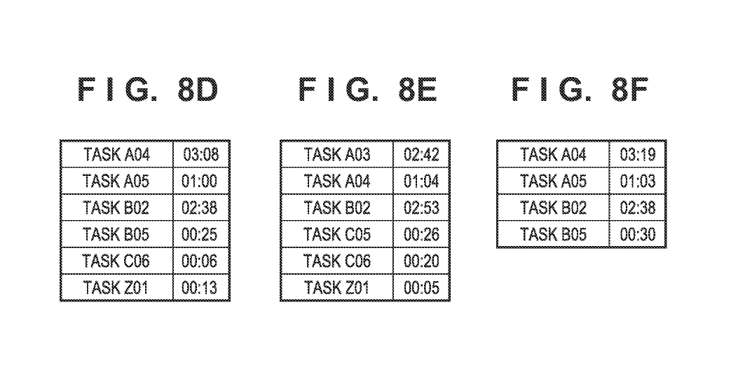

An example of processing of generating a report of a designated format by the server apparatus 130 according to this embodiment upon receiving the report generation request transmitted from the client terminal 110 in step S730 will be described next with reference to the flowchart of FIG. 7D. The process of each step shown in FIG. 7D can be implemented in the server apparatus 130 when the CPU of a control unit 132 reads out the control program 200 from a storage unit 133 and executes it. In addition, FIGS. 8A to 8F are views showing examples of totalization of the man-hours of tasks.

In step S741 of FIG. 7D, the control unit 132 obtains information (task information) necessary for generating a report designated by the report generation request from the client terminal 110 from a task estimation result 244 stored in the storage unit 133. The control unit 132 obtains task information in the totalization target period for each user from the task estimation result 244. Note that in the task estimation result 244, pieces of information as shown in FIG. 4C, which are generated by task estimation processing (FIG. 5B) described in the first embodiment, are recorded.

Next, in step S742, the task man-hour totalization unit 610 sets a totalization accuracy when totalizing task man-hours. The totalization accuracy can be designated as, for example, a continuous execution time of a task in totalizing man-hours. The man-hours of a task executed for a time more than the continuous execution time set as the totalization accuracy are totalized. This can exclude a task that is intermittently performed in the continuous execution time from the man-hour totalization target and adjust the totalization accuracy.

As the totalization accuracy set in step S742, a fixed setting may be used, or a setting that is changed in accordance with the report to be output may be used. For example, when generating a daily report of an individual, the continuous execution time is set to 1 min (the totalization accuracy is set high) to specifically know daily work contents. On the other hand, when generating a weekly report of an individual or a team report, the continuous execution time is set to 5 min (the totalization accuracy is set low) to know coarse work contents. Alternatively, when accepting the generation report settings by the client terminal 110 in step S720 of FIG. 7A, a designation of totalization accuracy may be accepted from the user. In this case, the designation of totalization accuracy is included in the report generation request and notified from the client terminal 110 to the server apparatus 130.

In step S743, based on the task information obtained in step S741, the task man-hour totalization unit 610 totalizes man-hours in each date for each user designated by the report generation request in accordance with the totalization accuracy designated in step S742. The task man-hour totalization unit 610 thus obtains the totalization value of man-hours in the designated period (for example, one week for a weekly report). For example, when the continuous execution time (that is, the totalization accuracy) is set to 1 min, the man-hours of estimated tasks are totalized time-serially, as shown in FIGS. 8A and 8B, thereby obtaining the totalization value of the man-hours of each task, as shown in FIGS. 8D and 8E. On the other hand, when the continuous execution time is set to 5 min or more, a task whose execution time is 5 min or less is regarded as the same as the immediately preceding task, and the man-hours of tasks are totalized, as shown in FIG. 8C, thereby obtaining the totalization value of the man-hours of each task, as shown in FIG. 8F.

Finally, in step S744, the task man-hour totalization unit 610 generates a report that visualizes the totalized man-hour in accordance with the report format designated by the report generation request. The generated report is transmitted by the output unit 250 to the client terminal 110 via the communication unit 131, and the report generation processing ends.

<Display Examples of Output Screens of Reports>

FIGS. 9A to 9E are views showing examples of output screens of reports transmitted from the server apparatus 130 in step S744, and show display examples of output screens displayed on the display unit 115 of the client terminal 110 in step S750. FIGS. 9A and 9B show daily reports of a user A, FIG. 9C shows a weekly report of the user A, and FIGS. 9D and 9E show examples of output of a weekly report of a team X to which the users A to E belong.

In various kinds of reports, a title that describes a report name, a user name/team name, and a totalization target date, theme names/task names, and information concerning man-hours are described. Note that the totalization results (totalization values) of man-hours shown in FIGS. 8D to 8F may directly be output. In some cases, however, the totalization values of a certain time unit (for example, 30 min in FIGS. 9A to 9D) are preferably output. In addition, the format of a report to be output is not limited to the formats (total man-hour) shown in FIGS. 9A to 9D. For example, a format that outputs the start time and the end time of each task may be used, or a format in which tasks of a predetermined man-hour or more are sorted in descending order of man-hour and output may be used.

Additionally, as shown in FIG. 9E, instead of setting the totalization unit of man-hours to be output to a task name, a totalization result may be displayed for each theme name, or a report for a specific theme name and task name may be output. In this case, the designation of the output format may be accepted from the user when the client terminal 110 accepts generation report settings in step S720 of FIG. 7A. The designation accepted from the user is included in the report generation request and notified from the client terminal 110 to the server apparatus 130.

As described above, in this embodiment, the server apparatus 130 transmits a report including a task estimation result by the task estimation unit 240 to the client terminal 110. The client terminal 110 displays the task estimation result on the display unit 115 based on the report received from the server apparatus 130. According to this embodiment, it is possible to automatically generate a report that visualizes daily work contents and easily grasp the work state of a user or a team member designated by the user.

### Third Embodiment

The first and second embodiments provide a mechanism configured to estimate a task from a work log of a user using machine learning and output the estimation result as a report. The third embodiment further provides a mechanism configured to allow a user to modify an estimated task. Note that portions different from the first and second embodiments will be described below.

<Functional Arrangement of Server Apparatus 130>

FIG. 6B is a block diagram showing an example of the functional arrangement of a server apparatus 130 implemented by a control program 200 executed by the server apparatus 130 according to this embodiment. In this embodiment, a modification unit 620 is further added to the functional arrangement (FIG. 6A) according to the second embodiment.

The modification unit 620 modifies a task estimated by a task estimation unit 240 in accordance with an instruction of a user. The modification unit 620 obtains the task after the modification by the user as a correct answer task for a work log corresponding to the estimated task. The modification unit 620 further pairs (associates) the work log with the correct answer task after the modification by the user and adds them to learning data 270.

A task man-hour totalization unit 610 performs retotalization of task man-hours and regeneration of a report after task modification based on the correct answer task after the modification by the user in the modification unit 620.

<Task Modification Acceptance Processing>

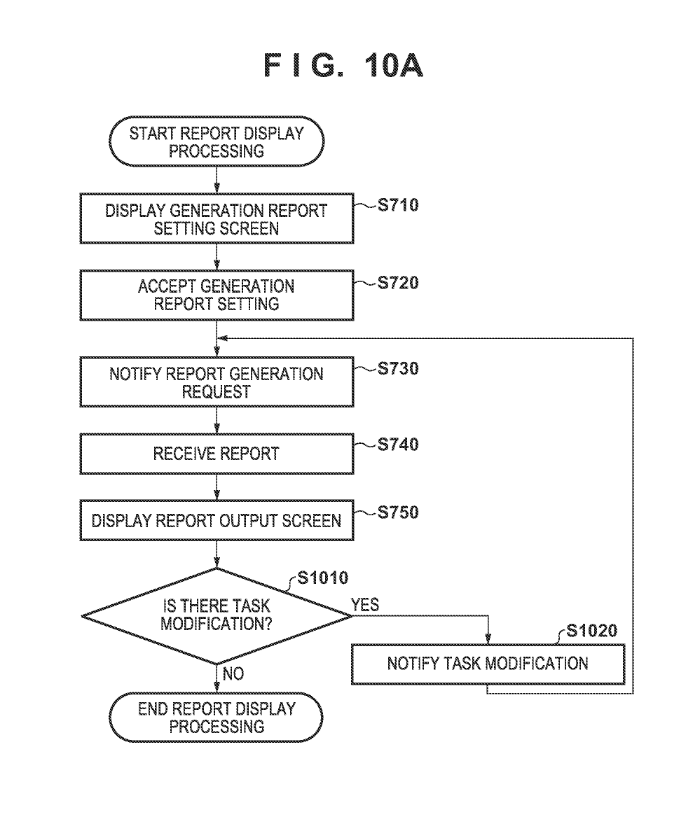

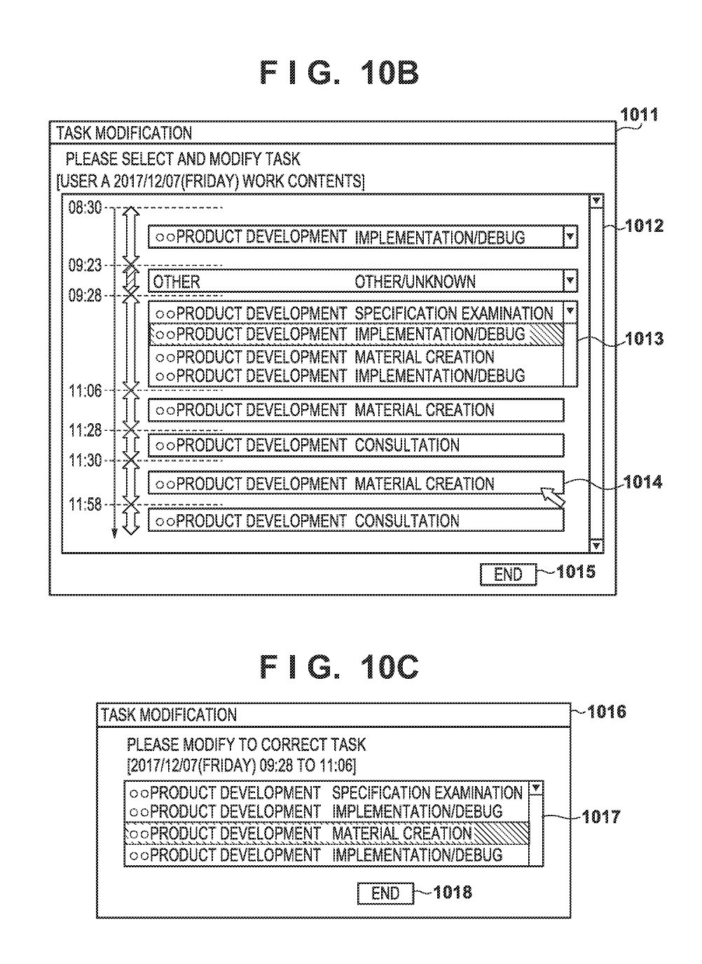

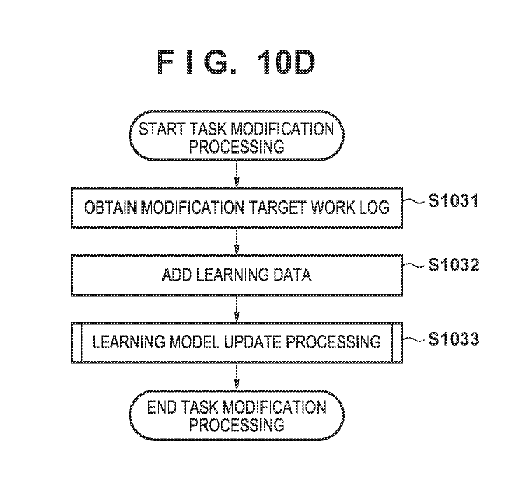

An example of processing of accepting, from the user, modification of a task estimated by the task estimation unit 240 in a work management system according to this embodiment will be described with reference to the flowchart of FIG. 10A. The process of each step shown in FIG. 10A can be implemented in a client terminal 110 when the CPU of a control unit 112 reads out a control program from a storage unit 113 and executes it.

In steps S710 to S750 of FIG. 10A, the same processing as in the second embodiment (FIG. 7A) is performed. However, in step S750, when the control unit 112 displays, on a display unit 115, an output screen 810 of a report received from the server apparatus 130, a modification button (not shown) is arranged on the screen in addition to an OK button 830.

In step S1010, the control unit 112 determines the presence/absence of modification by the user for a report displayed on the output screen 810. The control unit 112 determines, based on a notification from an operation unit 114, whether the modification button on the output screen 810 is pressed by the user. In a case in which the modification button is not pressed, and the OK button 830 is pressed, the control unit 112 determines that modification is absent, and ends the processing. On the other hand, in a case in which the modification button is pressed, the control unit 112 advance the process to step S1020, and displays a UI screen used to modify the task on the display unit 115.

FIG. 10B shows an example of a UI screen 1011 for task modification, which is displayed on the display unit 115 in a case in which the modification button is pressed on the output screen 810 (for example, FIGS. 9A and 9B) of a daily report of a user A. On the UI screen 1011, a work contents list 1012 of the user A and an end button 1015 are arranged.

The user can select a modification target task from the work contents list 1012 on the UI screen 1011 and select a correct task from a task list 1013.

Alternatively, when the user selects a task 1014 to be modified, the control unit 112 may display a UI screen 1016 as shown in FIG. 10C on the display unit 115 and accept, from the user, selection of a correct task from a task list 1017 on the UI screen. Tasks registered in a task list DB 260 are displayed in the task lists 1013 and 1017. Note that the method of accepting, in the client terminal 110, task modification by the user is not limited to the above-described method, and, for example, specifications that allow the user to manually set a start/end time and a task may be used.

The user can instruct the end of task modification by pressing the end button 1015 or 1018 on the UI screen 1011 or 1016. When the end button 1015 or 1018 is pressed, an operation unit 114 transmits, to the control unit 112, a modification completion notification including the modification contents accepted from the user on the UI screen 1011 or 1016.

Upon receiving the modification completion notification from the operation unit 114, in step S1020, the control unit 112 transmits a task modification notification to the server apparatus 130 and returns the process to step S730. The task modification notification includes the modification contents accepted from the user via the UI screen 1011 or 1016. Upon receiving, via a communication unit 131, the task modification notification transmitted from the client terminal 110, the server apparatus 130 executes task modification processing (FIG. 10D) to be described later in accordance with the received task modification notification.

When the process returns from step S1020 to step S730, the control unit 112 transmits a report generation request to the server apparatus 130 again. The control unit 112 thus requests the server apparatus 130 to execute report regeneration processing (step S740), outputs a report received from the server apparatus 130 (step S750), and repeats the above-described processing.

<Task Modification Processing>

An example of task modification processing executed by the server apparatus 130 according to this embodiment upon receiving the task modification notification transmitted from the client terminal 110 in step S1020 will be described with reference to the flowchart of FIG. 10D. The process of each step shown in FIG. 10D can be implemented in the server apparatus 130 when the CPU of a control unit 132 reads out the control program 200 from a storage unit 133 and executes it.

In step S1031, the modification unit 620 obtains a work log corresponding to a task before modification, which is the target of modification, from the storage unit 133 based on the received task modification notification. Next, in step S1032, the modification unit 620 adds, to the learning data 270 shown in FIG. 4B, data in which the modification target work log obtained in step S1031 and a correct answer task after modification by the user are paired.

After that, in step S1033, a learning model generation unit 280 executes learning model generation processing shown in FIG. 5A, as in the first embodiment, to update a learning model 241, and ends the processing. Note that the updating of the learning model 241 may be performed every time data is added to the learning data, may be performed every time a predetermined amount of data is accumulated as learning data, or may be performed at a predetermined date/time.

As described above, in this embodiment, the client apparatus accepts modification for a task estimation result displayed on the display unit 115 from the user, and notifies the server apparatus 130 of the accepted modification contents. The server apparatus 130 modifies the task estimated by the task estimation unit 240 in accordance with the modification contents notified from the client terminal 110. This allows the user to confirm the task estimation result and modify it to a correct task.

Additionally, in this embodiment, the server apparatus 130 adds the task after modification as a correct answer task to the learning data 270 in association with the work log used to estimate the task before the modification. Furthermore, the server apparatus 130 updates the learning model 241 by machine learning based on the learning data 270 for which the addition is performed. In this way, the learning model 241 is updated based on the task after modification, thereby improving the task estimation accuracy.

### Fourth Embodiment

In the first to third embodiments, the task estimation unit 240 (output task determination unit 243) outputs, as an estimation result, a task for which an evaluation value estimated by the learning model processing unit 242 is maximum. However, in some cases, the task estimation accuracy lowers depending on the contents of the work log used to estimate the task. Hence, the fourth embodiment further provides a mechanism configured to display a message to prompt a user to confirm an estimated task in accordance with the evaluation value of a task estimation result. Note that portions different from the first to third embodiments will be described below.

<Task Estimation Processing>

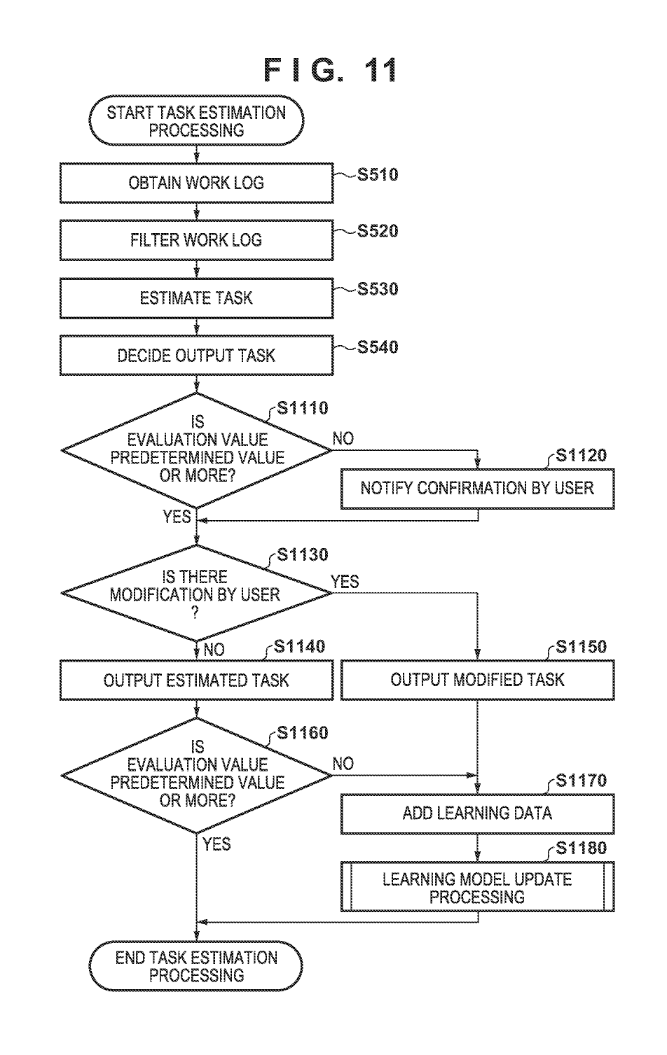

An example of estimation processing of estimating, in a server apparatus 130 according to this embodiment, a task for a work log 210 sent from a client terminal 110 will be described with reference to FIG. 11. The process of each step shown in FIG. 11 can be implemented in the server apparatus 130 when the CPU of a control unit 132 reads out a control program 200 from a storage unit 133 and executes it.

In steps S510 to S540 of FIG. 11, the same processing as in the first embodiment (FIG. 5B) is performed. A task estimation unit 240 (output task determination unit 243) thus determines an output task (estimates a task) using machine learning for the obtained work log, as in the first embodiment.

When the determination of the output task is completed, in step S1110, the output task determination unit 243 determines whether the evaluation value for the determined output task is equal to or more than a predetermined value (threshold). Here, the output task is a task for which the evaluation value estimated in step S530 is maximum. In step S1110, the maximum evaluation value is the determination target. In a case in which the evaluation value is less than the predetermined value, it is determined that the possibility that the task estimation has failed is high. In this case, the output task determination unit 243 advances the process to step S1120. On the other hand, in a case in which the evaluation value is equal to or more than the predetermined value, it is determined that the possibility that the task estimation has succeeded is high. In this case, the output task determination unit 243 advances the process to step S1130.

For example, assume that the threshold (predetermined value) of the evaluation value is set to 0.4 for a task estimation result 244 shown in FIG. 4C. In this case, for estimated task B05 corresponding to ID 002, the evaluation value is 0.97, and it is determined that the possibility that the task estimation has succeeded is high. On the other hand, for estimated task B01 corresponding to ID 009, the evaluation value is 0.24, and it is determined that the possibility that the task estimation has failed is high.

In step S1120, the control unit 132 notifies the client terminal 110 of an instruction message that instructs the user to confirm the task estimation result. Upon receiving the instruction message, the client terminal 110 requests the user to confirm the task estimation result as in a case in which task modification is accepted from the user in the third embodiment. The client terminal 110 can request the user to confirm the task estimation result using, for example, a UI screen 1016 as shown in FIG. 10C. For example, as a response to the above-described instruction message, the client terminal 110 notifies the server apparatus 130 of the presence/absence of task modification by the user and modification contents.

After that, in step S1130, a modification unit 620 determines the presence/absence of task modification by the user. If modification is absent, the process advances to step S1140. If modification is present, the process advances to step S1150. If task modification by the user is not performed, in step S1140, the output task determination unit 243 outputs the task (output task) estimated in step S540 as a final estimation result. Additionally, in step S1160, the output task determination unit 243 determines whether the evaluation value for the output task is equal to or more than the predetermined value, as in step S1110. If the evaluation value is equal to or more than the predetermined value, the processing ends. If the evaluation value is less than the predetermined value, the process advances to step S1170.

On the other hand, in step S1150, for the task as the target of modification by the user in the client terminal 110, the output task determination unit 243 outputs the task after modification as the final estimation result, and advances the process to step S1170.

In step S1170, the modification unit 620 pairs the work log used to estimate the task that has undergone the modification by the user (that is, the task determined to have failed in estimation) with the correct answer task that is the task after the modification by the user and adds them to learning data 270. In addition, the modification unit 620 pairs the work log used to estimate the task that has not undergone the modification by the user but has a low evaluation value (that is, the task which has succeeded in estimation but for which it is determined that the possibility that the estimation has failed is high) with the correct answer task and adds them to the learning data 270. The correct answer task in this case is the task estimated in step S540 (the task output in step S1140).

Furthermore, in step S1180, a learning model generation unit 280 executes learning model generation processing shown in FIG. 5A, as in the first embodiment, to update a learning model 241, and ends the processing. Note that the updating of the learning model 241 may be performed every time data is added to the learning data, may be performed every time a predetermined amount of data is accumulated as learning data, or may be performed at a predetermined date/time.

As described above, in this embodiment, in a case in which the evaluation value of the output task is less than the threshold, the server apparatus 130 transmits an instruction to request confirmation of the output task to the client terminal 110. The client terminal 110, in accordance with the instruction received from the server apparatus 130, displays, on a display unit 115, a message to prompt the user to confirm the output task, accepts modification for the output task from the user, and notifies the server apparatus 130 of the accepted modification contents. Since feedback from the user is appropriately received for a task estimation result corresponding to a low evaluation value, the task can be modified to a correct task.

In this embodiment, if modification by the user is performed in a case in which the evaluation value for the output task is less than the threshold, the server apparatus 130 adds the task after modification as a correct answer task to the learning data 270 in association with the input work log. In addition, if modification by the user is not performed, the server apparatus 130 adds the output task as a correct answer task to the learning data 270 in association with the input work log. In this way, for the task estimation result corresponding to the low evaluation value, the learning model 241 is appropriately updated based on the feedback result from the user, thereby improving the task estimation accuracy.

### Other Embodiments

Embodiment(s) of the present invention can also be realized by a computer of a system or apparatus that reads out and executes computer executable instructions (e.g., one or more programs) recorded on a storage medium (which may also be referred to more fully as ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-055102, filed Mar. 22, 2018, which is hereby incorporated by reference herein in its entirety.

What is claimed is:

1. A task management system including a server apparatus and configured to manage a task of a user by the server apparatus,
wherein the server apparatus comprises:
an obtainment unit configured to obtain learning data that associates a plurality of work logs each including work information of the user with a correct answer task for each work log of the plurality of work logs;
a generation unit configured to generate a learning model by machine learning based on the learning data obtained by the obtainment unit; and
an estimation unit configured to estimate a task of the user for an input work log by analyzing the input work log by the machine learning using the learning model generated by the generation unit.

2. The system according to claim 1, wherein the estimation unit generates, for each of a plurality of tasks registered in advance, an evaluation value indicating a relevance level between the input work log and the task by the machine learning using the learning model, and decides an output task to be output as an estimation result from among the plurality of tasks based on the generated evaluation value.

3. The system according to claim 2, wherein the estimation unit decides, as the output task, a task corresponding to a maximum evaluation value from among the plurality of tasks.

4. The system according to claim 2, further comprising a client terminal capable of communicating with the server apparatus,
wherein the server apparatus further comprises a transmission unit configured to transmit a report including the estimation result of the task by the estimation unit to the client terminal, and
the client terminal comprises a display unit configured to display the estimation result of the task based on the report received from the server apparatus.

5. The system according to claim 4, wherein the server apparatus further comprises a totalization unit configured to totalize, for each task, a man-hour that is a total execution time of the task in a predetermined period based on the estimation result of the task by the estimation unit, and
the transmission unit transmits the report generated by the totalization unit to the client terminal.

6. The system according to claim 4, wherein the client terminal further comprises:
an acceptance unit configured to accept, from the user, modification for the estimation result displayed by the display unit; and
a notification unit configured to notify the server apparatus of modification contents accepted by the acceptance unit, and
the server apparatus further comprises a modification unit configured to modify the task estimated by the estimation unit, in accordance with the modification contents notified from the client terminal.

7. The system according to claim 6, wherein the modification unit adds the task after the modification as a correct answer task to the learning data in association with the work log used to estimate the task before the modification, and
the generation unit updates the learning model by the machine learning based on the learning data for which the addition by the modification unit is performed.

8. The system according to claim 7, wherein in a case in which the evaluation value for the output task is less than a threshold, the transmission unit transmits an instruction to request confirmation of the output task to the client terminal, and
the acceptance unit causes, in accordance with the instruction received from the server apparatus, the display unit to display a message to prompt the user to confirm the output task, and accepts modification for the output task from the user.

9. The system according to claim 8, wherein in the case in which the evaluation value for the output task is less than the threshold,
if the modification by the user is performed, the modification unit adds the task after the modification as the correct answer task to the learning data in association with the input work log, and
if the modification by the user is not performed, the modification unit adds the output task as the correct answer task to the learning data in association with the input work log.

10. The system according to claim 1, wherein the server apparatus further comprises a filtering unit configured to perform filtering processing for extracting an element necessary for the generation of the learning model by the generation unit, with respect to the work log included in the learning data obtained by the obtainment unit.

11. The system according to claim 10, wherein the filtering unit further performs filtering processing for extracting an element necessary for the estimation of the task by the estimation unit, with respect to the input work log.

12. The system according to claim 1, wherein each of the plurality of work logs and the input work log includes at least one of a personal computer operation log concerning an operation on a personal computer by the user, an action analysis log obtained from one of video information and voice information and concerning an action of the user, an action schedule of the user, and an action history of the user.

13. A server apparatus of a task management system configured to manage a task of a user, comprising:
an obtainment unit configured to obtain learning data that associates a plurality of work logs each including work information of the user with a correct answer task for each work log of the plurality of work logs;
a generation unit configured to generate a learning model by machine learning based on the learning data obtained by the obtainment unit; and
an estimation unit configured to estimate a task of the user for an input work log by analyzing the input work log by the machine learning using the learning model generated by the generation unit.

14. A method of controlling a server apparatus of a task management system configured to manage a task of a user, the method comprising:
obtaining learning data that associates a plurality of work logs each including work information of the user with a correct answer task for each work log of the plurality of work logs;
generating a learning model by machine learning based on the obtained learning data; and
estimating a task of the user for an input work log by analyzing the input work log by the machine learning using the generated learning model.

15. A non-transitory computer-readable storage medium storing a computer program for causing a computer to execute a method of controlling a server apparatus of a task management system configured to manage a task of a user, the method comprising:
obtaining learning data that associates a plurality of work logs each including work information of the user with a correct answer task for each work log of the plurality of work logs;
generating a learning model by machine learning based on the obtained learning data; and
estimating a task of the user for an input work log by analyzing the input work log by the machine learning using the generated learning model.
